(19) United States
(12) Patent Application Publication
(10) Pub. No.: US 2012/0315033 A1
(43) Pub. Date: Dec. 13, 2012

(54) OPTICAL COMMUNICATION DEVICE

(75) Inventor: Hideaki SUGIYA, Fujisawa (JP)

(73) Assignee: FUJITSU LIMITED, Kawasaki-shi (JP)

(21) Appl. No.: 13/480,668

(22) Filed: May 25, 2012

(30) Foreign Application Priority Data
Jun. 8, 2011 (JP) 2011-127911

(51) Int. Cl. H04B 10/08; H04J 14/02

(52) U.S. Cl. 398/34

(57) ABSTRACT

There is provided an optical communication device includes a first transmission unit including an optical source configured to emit a reference optical pulse, an optical splitter configured to branch the reference optical pulse, and generate a plurality of optical pulses, a plurality of optical fibers configured to have different length to set various time delays for the optical pulses, and a first optical connector, and a second transmission unit including a second optical connector coupled to the first optical connector, an optical multiplexer configured to multiplex the optical pulses that have passed through optical ports of the first and second optical connectors, and generate an optical pulse train, an optical receiver configured to convert the optical pulse train into an electric pulse train, and a measuring processor configured to determine communication states of the optical ports, based on the levels of electric pulses included in the electric pulse train.

### CROSS-REFERENCE TO RELATED APPLICATION

This application is based upon and claims the benefit of priority of the prior Japanese Patent Application No. 2011-127911, filed on Jun. 8, 2011, the entire contents of which are incorporated herein by reference.

### FIELD

The embodiment discussed herein is related to an optical communication device.

### BACKGROUND

In recent years, an optical network in which wavelength division multiplexing (WDM) is performed has been put into practical use. With an increase in the amount of internet traffic and the like, the capacity of the optical network tends to increase. With an increase in the communication capacity of an optical communication device, the number of optical ports included in the single optical communication device tends to increase.

The optical communication device includes a line card, a wavelength multiplexer/demultiplexer, an optical switch, and an optical amplifier. The line card includes a transponder that converts an input signal into signal light that is able to be multiplexed to the WDM signal. A connector such as a multi-fiber push-on (MPO) connector having multiple ports is used for an optical communication device that achieves an add/drop function.

The MPO connector is a multi-fiber connector that is provided for a connection between racks or between devices and can be easily detached by a push-pull operation. The MPO connector has been widely used as a multi-port connector that is connected to a multi-fiber cable.

As a conventional technique, a technique for conducting a test for an optical path without using an optical power meter has been proposed.

Japanese Laid-open Patent Publication No. 10-170393 is an example of the related art.

### SUMMARY

According to an aspect of the embodiment, there is provided an optical communication device including a first transmission unit including an optical source configured to emit a reference optical pulse, an optical splitter configured to branch the reference optical pulse, and generate a plurality of optical pulses, a plurality of optical fibers configured to have different length to set various time delays for the optical pulses, and a first optical connector, and a second transmission unit including a second optical connector coupled to the first optical connector, an optical multiplexer configured to multiplex the optical pulses that have passed through optical ports of the first and second optical connectors, and generate an optical pulse train, an optical receiver configured to convert the optical pulse train into an electric pulse train, and a measuring processor configured to receive the electric pulse train and determine communication states of the optical ports, based on the levels of electric pulses included in the electric pulse train.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of the configuration of an optical communication device;

FIG. 2 is a diagram illustrating an example of the configuration of an optical communication device;

FIG. 3 is a flowchart of operations of transmitting optical pulses;

FIG. 4 is a diagram illustrating connection between optical ports of optical connectors;

FIG. 5 is a timing chart of optical pulses;

FIG. 6 is a timing chart of an optical pulse train and a reference optical pulse;

FIG. 7 is a timing chart of an optical pulse train, a reference optical pulse, and an electric pulse train;

FIG. 8 is a timing chart illustrating an operation of measuring communication states of the optical ports;

FIG. 9 is a table illustrating intervals between electric pulses;

FIG. 10 is a diagram illustrating intervals between the electric pulses;

FIG. 11 is a diagram illustrating another example of the configuration of the optical communication device;

FIG. 12 is a timing chart of an optical pulse train, a reference optical pulse, and an electric pulse train;

FIG. 13 is a diagram illustrating another example of the configuration of the optical communication device;

FIG. 14 is a diagram illustrating another example of the configuration of the optical communication device;

FIG. 15 is a diagram illustrating another example of the configuration of the optical communication device;

FIG. 16 is a diagram illustrating another example of the configuration of the optical communication device;

FIG. 17 is a diagram illustrating another example of the configuration of the optical communication device; and

FIG. 18 is a diagram illustrating another example of the configuration of the optical communication device.

### DESCRIPTION OF EMBODIMENT

For an operation of the optical communication device, it is rare that signal lights in all available wavelength bands are used at an early stage of the operation of the multiplexer/demultiplexer and the optical switch. Normally, signal lights in a certain wavelength band are selected and used.

In order to start the operation, a substitute optical source is tentatively used in advance to test the optical port that is included in the MPO connector, which is not used in the operation. The optical communication device performs a measurement in order to determine a communication state that indicates whether or not the interested optical port causes main signal light to normally pass through the optical port.

Traditionally, in order to determine the communication states of optical ports, a plurality of test optical sources for emitting continuous light are prepared before the start of the operation. Then, the optical communication device performs a measurement in order to determine the communication states. However, optical sources for measurement, receivers and the like have to be provided as many as the number of the optical ports. This increases the size and cost of a measuring system and the time and effort desired in advance of the start of the operation. Under such circumstances, there is an increasing demand for a technique for easily measuring communication states of optical ports whose number tends to increase.

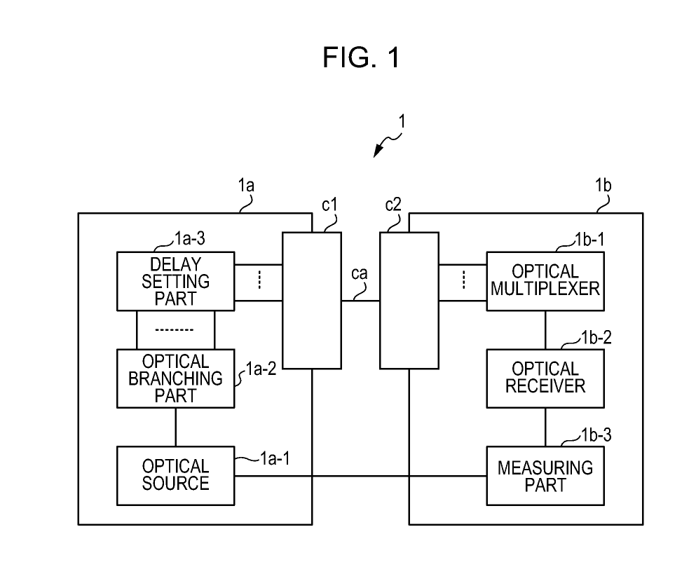

Hereinafter, an embodiment is described with reference to the accompanying drawings. FIG. 1 is a diagram illustrating an example of the configuration of an optical communication device. An optical communication device 1 includes a transmission unit 1a (first transmission unit) and a transmission unit 1b (second transmission unit). The transmission unit 1a includes an optical source 1a-1, an optical branching part 1a-2, a delay setting part 1a-3, and an optical connector c1 (first optical connector). The transmission unit 1b includes an optical multiplexer 1b-1, an optical receiver 1b-2, a measuring part 1b-3, and an optical connector c2 (second optical connector). The optical connectors c1 and c2 are MPO connectors, for example. The optical connectors c1 and c2 are connected to each other through a connector cable ca.

The optical source 1a-1 emits a reference optical pulse. The optical branching part 1a-2, for example, formed by an optical splitter, branches the reference optical pulse and thereby generates a plurality of optical pulses. The delay setting part 1a-3, for example, formed by a plurality of optical fibers, sets different time delays for each of the plurality of optical pulses.

The optical multiplexer 1b-1 multiplexes the optical pulses transmitted through optical ports of the optical connectors c1 and c2 and thereby generates an optical pulse train. The optical receiver 1b-2 converts the optical pulse train into an electric pulse train. The measuring part 1b-3, for example, formed by a measuring processor, determines communication states of the optical ports on the basis of the levels of electric pulses included in the electric pulse train.

The optical communication device 1 branches the reference optical pulse emitted from the single optical source 1a-1 into the plurality of optical pulses, sets the different time delays for each of the branched optical pulses, multiplexes the optical pulses transmitted through the optical ports of the optical connectors c1 and c2, causes the optical receiver 1b-2 to receive the optical pulses, and measures the levels of the electric pulses. Thus, the optical communication device 1 can easily measure the communication states of the optical ports and improve the efficiency of the measurement.

Traditionally, a plurality of optical sources for measurement and a plurality of devices (such as receivers) for measurement are connected to respective optical ports, and communication states of the optical ports are measured. However, the optical communication device 1 can measure the levels of the electric pulses using the aforementioned simple constituent regardless of the number of optical ports. Thus, the size and cost of a measuring system can be reduced.

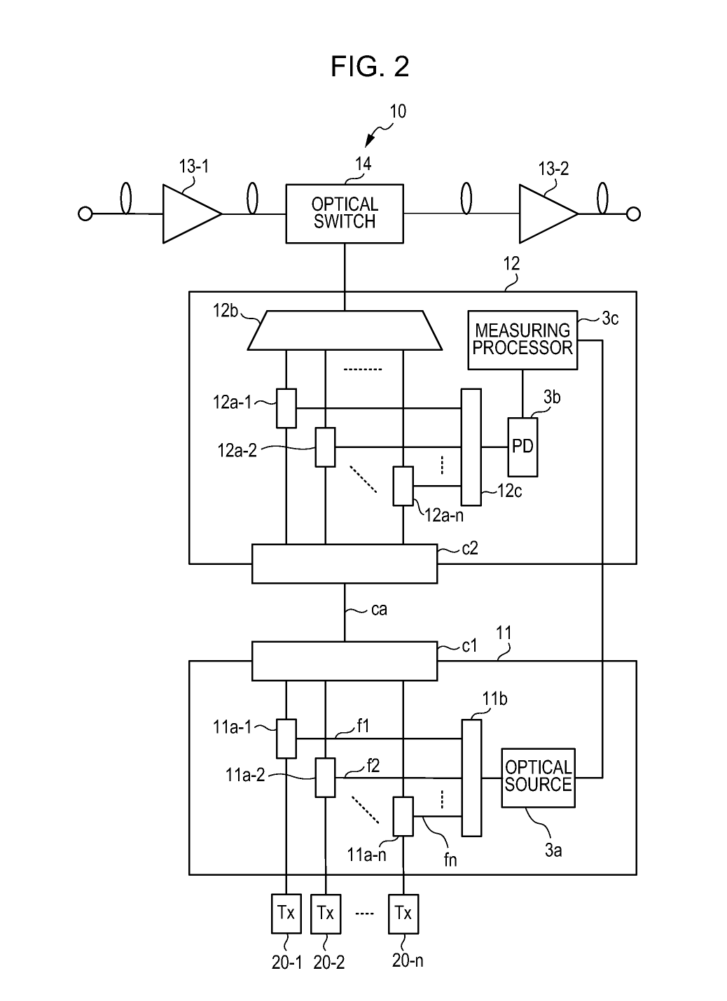

Next, a configuration of the optical communication device 1 is described. FIG. 2 is a diagram illustrating an example of the detailed configuration of the optical communication device 1. An optical communication device 10 includes an optical add controller 11, an optical multiplexing controller 12, optical amplifiers 13-1, 13-2, and an optical switch 14.

The optical add controller 11 includes optical couplers 11a-1 to 11a-n, an optical coupler 11b, an optical source 3a, and an optical connector c1. The optical multiplexing controller 12 includes optical couplers 12a-1 to 12-n, an optical multiplexer 12b, an optical coupler 12c, a photodiode (PD) 3b, a measuring processor 3c, and an optical connector c2. The optical connector c1 of the optical add controller 11 is connected to the optical connector c2 of the optical multiplexer 12 through a connector cable (also called multi-fiber cable) ca.

Optical transmitters 20-1 to 20-n are connected to the optical couplers 11a-1 to 11a-n, which are in the optical add controller 11, respectively, and output main signal lights, each have different wavelengths. The optical source 3a emits a reference optical pulse (with wavelengths different from that of the main signal light) on the basis of a timing instruction transmitted from the measuring processor 3c. The optical coupler 1b branches the reference optical pulse into n number of optical pulses and outputs the branched optical pulses to the optical couplers 11a-1 to 11a-n.

The optical coupler 11b is connected to the optical couplers 11a-1 to 11a-n through optical fibers f1 to fn. Time delays of optical signals that are different from each other are set. The optical pulses, which are branched by the optical coupler 11b, reach the optical couplers 11a-1 to 11a-n after the time delays set for the optical fibers f1 to fn.

The optical couplers 11a-1 to 11a-n couple the main signal light transmitted from the optical transmitters 20-1 to 20-n with the optical pulses and thereby generate coupled light. The optical couplers 11a-1 to 11a-n output the coupled light through the optical connectors c1 and c2 to the optical couplers 12a-1 to 12a-n.

The optical couplers 12a-1 to 12a-n receive the coupled light through the optical connector c2, branch the coupled light into the main signal light and the optical pulses, transmit the main signal light to the optical multiplexer 12b and transmit the optical pulses to the optical coupler 12c.

The optical multiplexer 12b multiplexes the main signal light with the different wavelengths and transmits the multiplexed light to the optical switch 14. The optical amplifier 13-1 amplifies received main signal light. The optical switch 14 switches the amplified main signal light and the multiplexed light output from the optical multiplexer 12b and outputs (optically multiplexed) WDM main signal light with a selected wavelength. The optical amplifier 13-2 amplifies the light output from the optical switch 14 and transmits the amplified light to a node located at the next stage.

On the other hand, the optical coupler 12c multiplexes a plurality of optical pulses and thereby generates an optical pulse train. Then, the optical coupler 12c outputs the generated optical pulse train. The PD 3b converts the optical pulse train output from the optical coupler 12c into an electric pulse train. The measuring processor 3c receives the electric pulse train, measures the levels of electric pulses included in the electric pulse train, and determines the communication states of the optical ports on the basis of the levels of the electric pulses. For example, the measuring processor 3c includes at least one of a circuit, a field-programmable gate array (FPGA), and a processor, and this feature is applied to the embodiment described below.

The measuring processor 3c is connected to a maintenance terminal (not illustrated). The measuring processor 3c receives information data on settings for a measurement process from the maintenance terminal and controls display of a measurement result for the maintenance terminal.

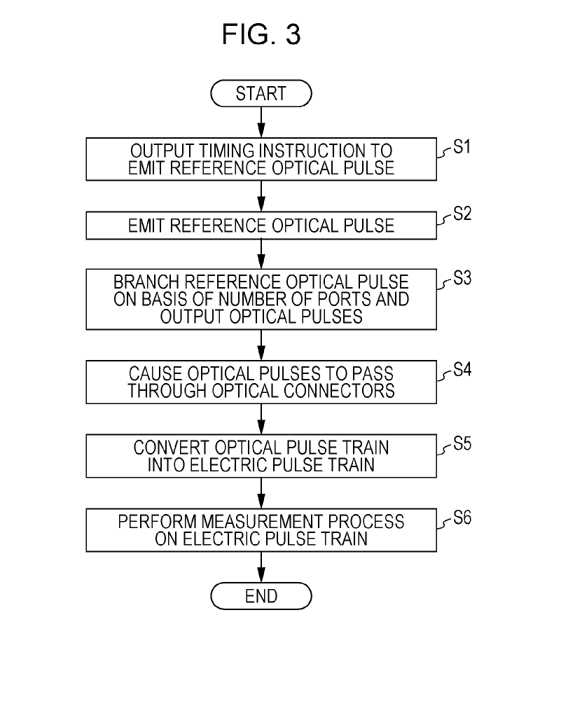

Next, a process of measuring the communication states of the optical ports is described below. FIG. 3 is a flowchart of operations of transmitting optical pulses. FIG. 3 illustrates the flow of the operations from the emission of the reference optical pulse, which is light to be measured, through the conversion of the optical pulses into the electric pulses to the reception of the electric pulses by the measuring processor 3c. It is assumed that the optical pulses are transmitted through four ports of each of the optical connectors c1 and c2.

In S1, the measuring processor 3c outputs a timing instruction to emit the reference optical pulse.

In S2, the optical source 3a emits the reference optical pulse on the basis of the timing instruction.

In S3, the optical coupler 11b branches the reference optical pulse into four optical pulses p1 to p4 and outputs the optical pulses p1 to p4.

In S4, the optical pulses p1 to p4 flow in the optical fibers f1 to f4, respectively, while different time delays are given to the optical pulses p1 to p4 by the optical fibers f1 to f4. In S4, the optical pulses p1 to p4 reach the optical couplers 11a-1 to 11a-4, respectively, then pass through the optical couplers 11a-1 to 11a-4, the optical connectors c1 and c2 and the optical couplers 12a-1 to 12a-4, and reach the optical coupler 12c.

In S5, the optical coupler 12c multiplexes the optical pulses p1 to p4 and thereby generates an optical pulse train. Then, the PD 3b converts the optical pulse train into an electric pulse train.

In S6, the measuring processor 3c receives the electric pulse train and measures the communication states of the four optical ports of each of the optical connectors c1 and c2.

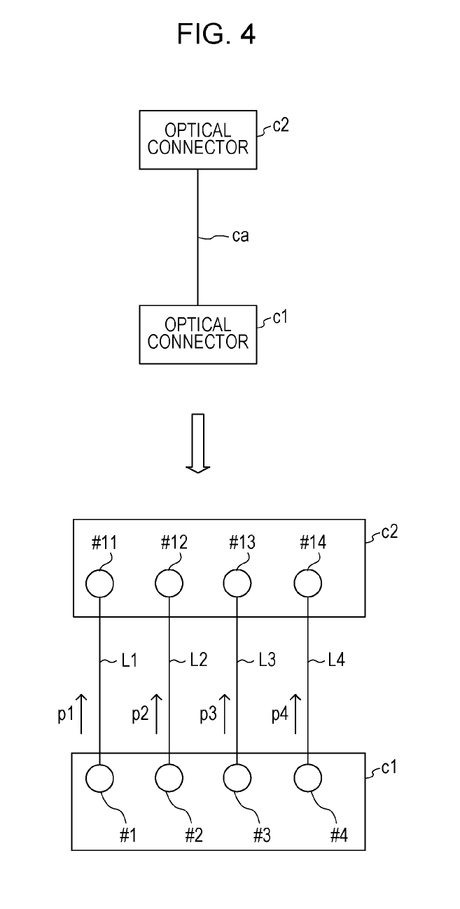

FIG. 4 is a diagram illustrating the connection between optical ports of the optical connectors c1 and of c2. The four optical ports (to be measured) of the optical connector c1 are indicated by #1 to #4, while the four optical ports (to be measured) of the optical connector c2 are indicated by #11 to #14.

The optical port #1 and the optical port #11 are connected to each other through a port line L1. The optical port #2 and the optical port #12 are connected to each other through a port line L2. The optical port #3 and the optical port #13 are connected to each other through a port line L3. The optical port #4 and the optical port #14 are connected to each other through a port line L4. The port lines L1 to L4 are inter-port connection lines included in the multi-fiber cable ca.

The optical pulse p1 passes through the port line L1 located between the optical ports #1 and #11. The optical pulse p2 passes through the port line L2 located between the optical ports #2 and #12. The optical pulse p3 passes through the port line L3 located between the optical ports #3 and #13. The optical pulse p4 passes through the port line L4 located between the optical ports #4 and #14.

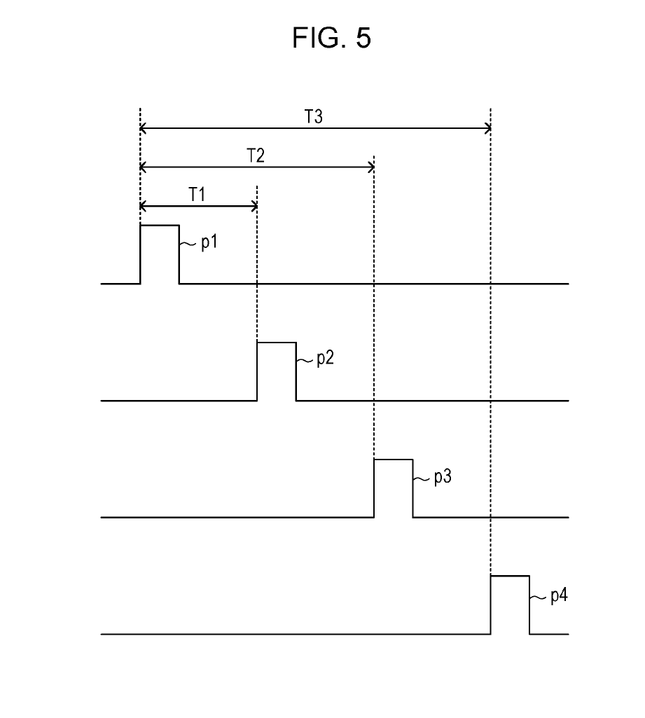

FIG. 5 is a timing chart illustrating the waveforms of the optical pulses p1 to p4. Specifically, FIG. 5 illustrates the waveforms of the optical pulses p1 to p4 when predetermined time delays are given to the respective optical pulses p2 to p4 according to the states of the optical fibers f2 to f4, and the optical pulses p1 to p4 reach the optical couplers 11a-1 to 11a-4, respectively.

The delay of the optical pulse p2 relative to the optical pulse p1 is T1. The delay of the optical pulse p3 relative to the optical pulse p1 is T3. The delay of the optical pulse p4 relative to the optical pulse p1 is T4.

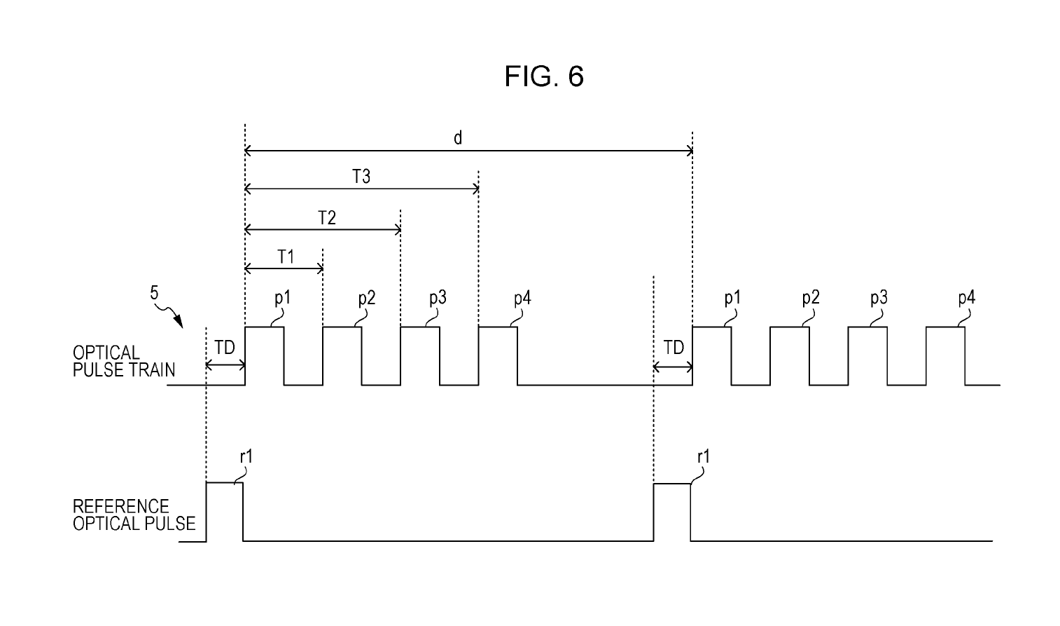

FIG. 6 is a timing chart illustrating the optical pulse train and the reference optical pulse. The optical pulse train that is indicated by reference number 5 has a waveform formed by arranging the optical pulses p1 to p4 (illustrated in FIG. 5) on a line. A cycle d is equal to an interval between reference optical pulses r1 emitted from the optical source 3a. A time delay of the beginning (rising edge of the optical pulse p1) of the optical pulse train 5 relative to a rising edge of the reference optical pulse r1 is indicated by TD.

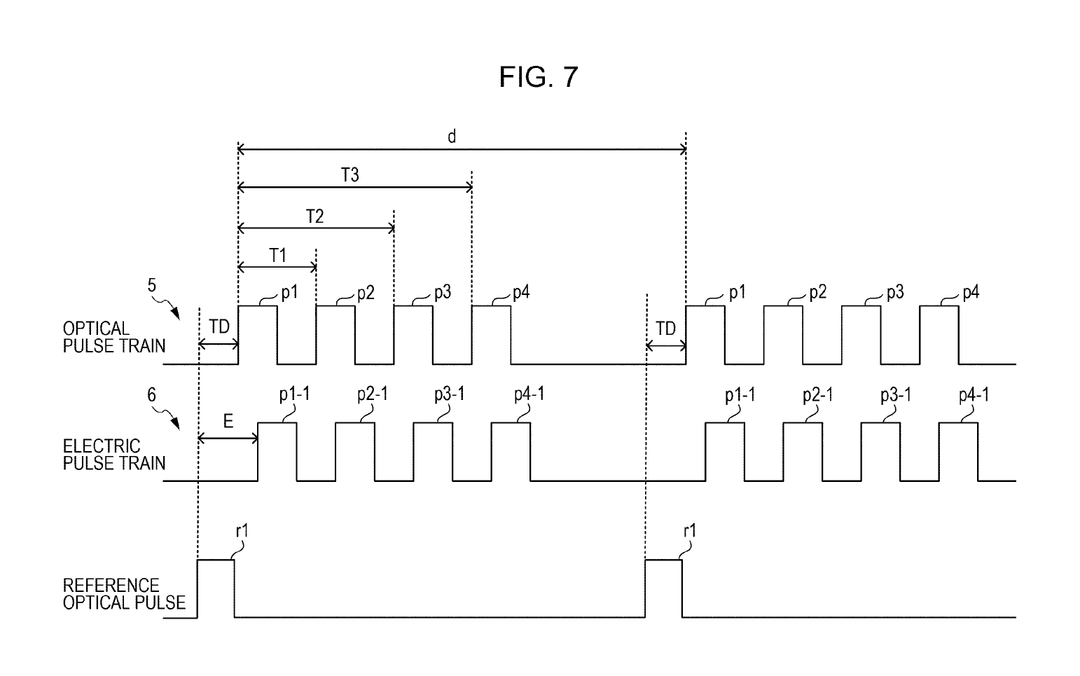

FIG. 7 is a timing chart illustrating an optical pulse train, a reference optical pulse, and an electric pulse train. The electric pulse train (indicated by reference number 6) to be measured is output from the PD 3b. Electric pulses that are converted from the optical pulses p1, p2, p3, and p4 are represented by p1-1, p2-1, p3-1, and p4-1, respectively.

The measuring processor 3c calculates an expected value (estimated value) of a time difference between the beginning of the reference optical pulse r1 and the beginning of the electric pulse train 6 according to the following Equation (1):

E=TD+L/(c/n) (1)

where L is the length of the connector cable ca, c is the speed of light, and n is a refraction index of the connector cable ca.

The measuring processor 3c can estimate, on the basis of the result of the aforementioned calculation, that the measuring processor 3c receives the beginning of the electric pulse train 6 after a time of the expected value elapses after the rising edge of the reference optical pulse r1. Thus, the measuring processor 3c identifies, as the first pulse of the electric pulse train 6, a pulse received after the time of the expected value elapses after the rising edge of the reference optical pulse r1.

The measuring processor 3c identifies, in advance, the order of the optical pulses p1 to p4 from the beginning of the electric pulse train 6 and the pulse intervals (T1 to T3). Thus, the measuring processor 3c can identify the electric pulses p1-1 to p4-1 included in the electric pulse train 6 or identify the optical ports (of the optical connectors c1 and c2) through which the optical pulses p1 to p4 that correspond to the electric pulses p1-1 to p4-1 have passed.

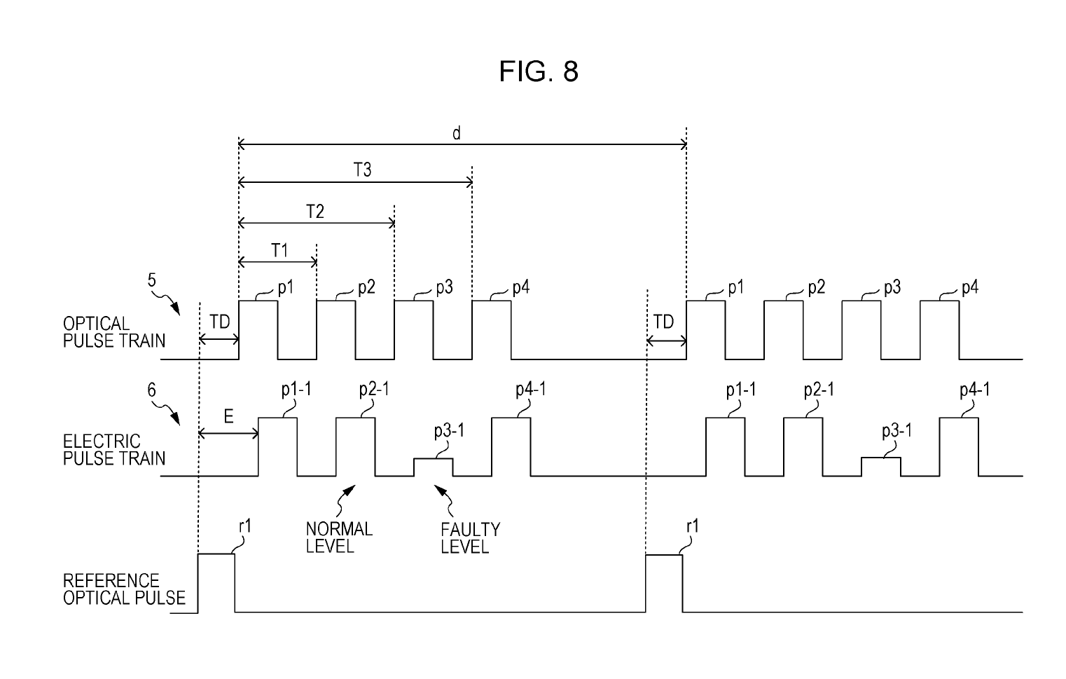

FIG. 8 is a timing chart illustrating operations of measuring the communication states of the optical ports. It is assumed that the electric pulses p1-1, p2-1 and p4-1 have normal levels and the electric pulse p3-1 has a faulty level.

When the measuring processor 3c receives a pulse signal after the time of the calculated expected value elapses, the measuring processor 3c identifies the received pulse signal as the first pulse p1-1 of the electric pulse train. The measuring processor 3c measures the level of the electric pulse p1-1 and determines whether or not the electric pulse p1-1 has a normal level. When the level of the electric pulse p1-1 exceeds a preset level, the measuring processor 3c determines that the level of the electric pulse p1-1 is normal. In this example, the measuring processor 3c identifies the level of the first electric pulse p1-1 as a normal level.

The measuring processor 3c identifies, as the electric pulse p2-1, a pulse received after the time T1 elapses after the reception of the electric pulse p1-1. The measuring processor 3c measures the level of the electric pulse p2-1 and identifies the level of the electric pulse p2-1 as a normal level.

The measuring processor 3c identifies, as the electric pulse p3-1, a pulse received after the time T2 elapses after the reception of the electric pulse p1-1. The measuring processor 3c measures the level of the electric pulse p3-1 and identifies the level of the electric pulse p3-1 as a faulty level since the level of the electric pulse p3-1 does not exceed the preset level.

The measuring processor 3c identifies, as the electric pulse p4-1, a pulse received after the time T3 elapses after the reception of the electric pulse p1-1. The measuring processor 3c measures the level of the electric pulse p4-1 and identifies the level of the electric pulse p4-1 as a normal level.

Since the level of the electric pulse p3-1 is determined to be the faulty level, it is apparent that a path in which the optical pulse p3 flows has a failure. For example, the measuring processor 3c can determine that the optical port #3 or #13 (of the optical connector c1 or c2) in which the optical pulse p3 flows has a failure (attachment of contamination or the like). Alternatively, the measuring processor 3c can determine that a path that is included in a device in which the optical pulse p3 flows has a failure.

Next, a modified example of the identifications of the pulses is described. In the modified example, time delays are set for the pulses using a predetermined function, and the pulses are identified. For example, the function f(x)=x². Time intervals between pulses that flow between port lines Ln to Lm are represented by tn to tm, respectively.

In the modified example, time intervals between the pulses that flow between the port lines L1 to L4 are t1−2=f(1)=1, t2−t3=f(2)=4, t3−t4=f(3)=9, and t4−t5=f(4)=16, respectively.

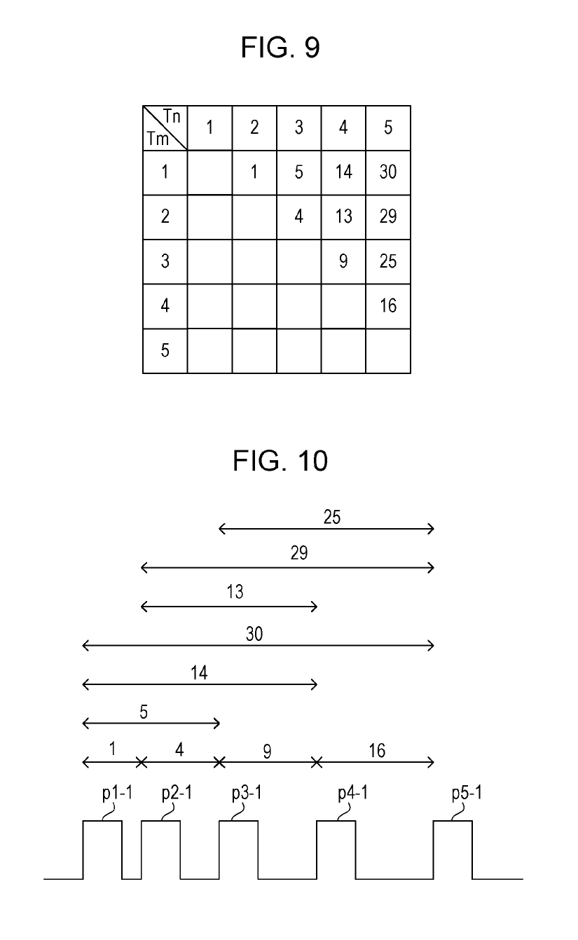

FIG. 9 is a table illustrating the time intervals between the electric pulses. FIG. 10 is a diagram illustrating the time intervals between the electric pulses. Time delays are set for the optical fibers f1 to f4 so that the time intervals (illustrated in FIGS. 9 and 10) between the pulses are provided. The measuring processor 3c identifies, in advance, the time intervals between the pulses for one cycle of the electric pulse train 6.

It is assumed that the units of the aforementioned values are nanoseconds (ns) and the second electric pulse of the one cycle is received after a time of 14 ns elapses after reception of the first electric pulse of the one cycle. Based on this assumption, it is apparent that the electric pulse p2-1 that is to be received after a time of 1 ns elapses after the reception of the first electric pulse has a loss and the electric pulse p3-1 that is to be received after a time of 5 ns elapses after the reception of the first electric pulse has a loss.

It is, therefore, apparent that paths in which the optical pulses p2 and p3 have failures. For example, the measuring processor 3c can determine that the optical port #2 or #12 (of the optical connector c1 or c2) in which the optical pulse p2 flows has a failure. In addition, the measuring processor 3c can determine that the optical port #3 or #13 (of the optical connector c1 or c2) in which the optical pulse p3 flows has a failure.

Next, modified examples of the optical communication device 10 are described. Parts in which optical pulses to be measured flow are mainly described with illustrated configurations.

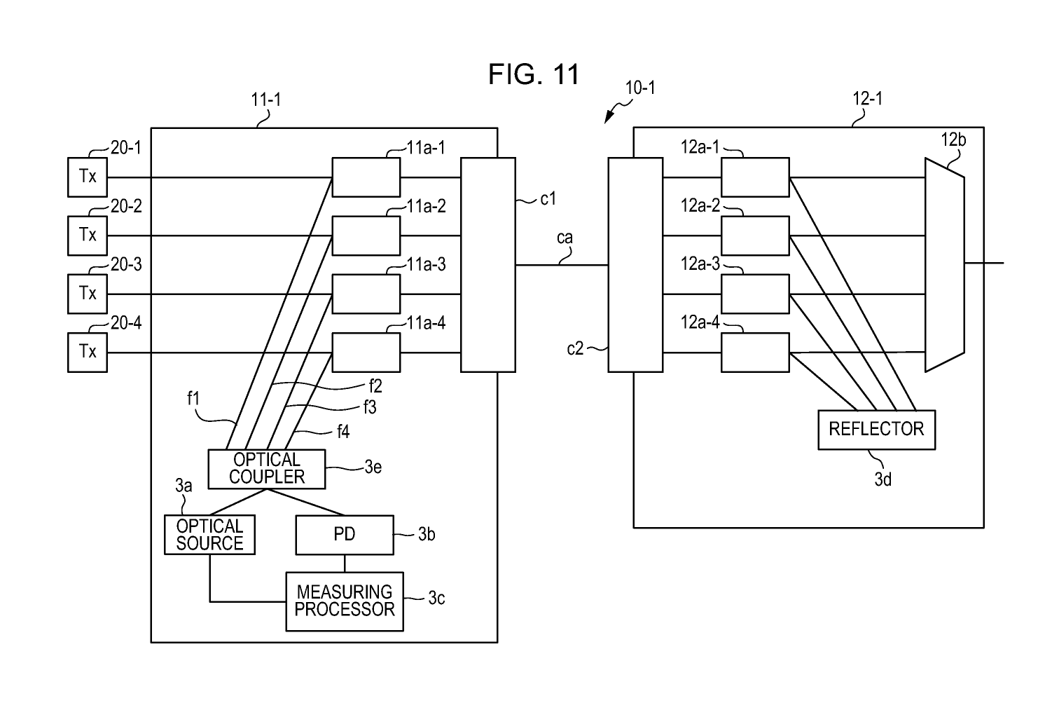

FIG. 11 is a diagram illustrating an example of the configuration of the optical communication device 10. An optical communication device 10-1 includes an optical add controller 11-1 and an optical multiplexer 12-1. The optical add controller 11-1 includes the optical couplers 11a-1 to 11a-4, an optical coupler 3e, the optical source 3a, the PD 3b, the measuring processor 3c and the optical connector c1. The optical multiplexer 12-1 includes the optical couplers 12a-1 to 12a-4, the optical multiplexer 12b, a reflector 3d and the optical connector c2. For example, the reflector 3d includes at least one of a mirror and a loop mirror, and this feature is applied to the embodiment described below.

The optical source 3a emits a reference optical pulse (with a different wavelength from main signal light) on the basis of a timing instruction transmitted from the measuring processor 3c. The optical coupler 3e branches the reference optical pulse into optical pulses and outputs the branched optical pulses to the optical couplers 11a-1 to 11a-4.

The optical coupler 3e is connected to the optical couplers 11a-1 to 11a-4 through the optical fibers f1 to f4 for which the time delays that are different from each other are set. The optical pulses, which are branched by the optical coupler 3e, reach the optical couplers 11a-1 to 11a-4 after the time delays set for the optical fibers f1 to f4.

The optical coupler 11a-1 to 11a-4 couple the optical pulses with main signal light transmitted from optical transmitters 20-1 to 20-4 and thereby generate coupled light. The optical couplers 11a-1 to 11a-4 output the coupled light through the optical connectors c1 and c2 to the optical couplers 12a-1 to 12a-4.

The optical couplers 12a-1 to 12a-4 branch the coupled light received through the optical connector c2 into the main signal light and the optical pulses, transmit the main signal light to the optical multiplexer 12b and transmit the optical pulses to the reflector 3d.

The optical multiplexer 12b multiplexes the main signal light with different wavelengths and transmits the main signal light to a processor located at the next stage. The reflector 3d reflects the optical pulse (light) output from the optical coupler 12a-1 so as to return the reflected optical pulse to the optical coupler 12a-1, and reflects the optical pulse (light) output from the optical coupler 12a-2 so as to return the reflected optical pulse to the optical coupler 12a-2. In the same manner, the reflector 3d reflects the optical pulse (light) output from the optical coupler 12a-3 so as to return the reflected optical pulse to the optical coupler 12a-3, and reflects the optical pulse (light) output from the optical coupler 12a-4 so as to return the reflected optical pulse to the optical coupler 12a-4.

The optical couplers 12a-1 to 12a-4 output the optical pulses reflected and returned by the reflector 3d toward the optical connector c2. When the optical couplers 11a-1 to 11a-4 receive the reflected optical pulses through the optical connector c1, the optical couplers 11a-1 to 11a-4 transmit the reflected optical pulses to the optical couplers 3e.

The optical coupler 3e multiplexes the four reflected optical pulses and thereby generates an optical pulse train. The optical coupler 3e outputs the generated optical pulse train to the PD 3b. The PD 3b converts the optical pulse train output from the optical coupler 3e into an electric pulse train. The measuring processor 3c receives the electric pulse train from the PD 3b. The measuring processor 3c measures the levels of electric pulses included in the electric pulse train and determines the communication states of the optical ports on the basis of the levels of the electric pulses.

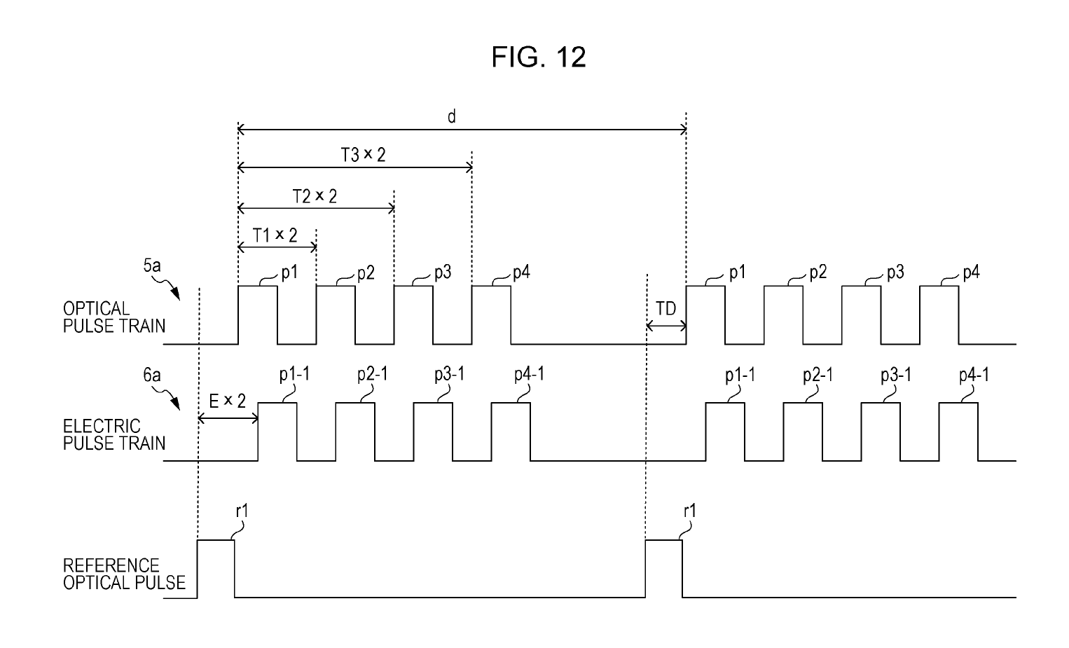

FIG. 12 is another timing chart illustrating an optical pulse train, a reference optical pulse, and an electric pulse train. An optical pulse train 5a includes the optical pulses p1 to p4. Since the optical pulses p1 to p4 are reflected and returned by the reflector 3d, time intervals between the optical pulse p1 and the optical pulses p2 to p4 are twice as long as the time intervals T1 to T3 illustrated in FIG. 7. An electric pulse train 6a is output from the PD 3b. Time intervals between the electric pulse p1-1 and the electric pulses p2-1 to p2-4 are twice as long as the time intervals (illustrated in FIG. 7) between the electric pulse p1-1 and the electric pulses p2-1 to p2-4. It should be noted that an expected value E that is calculated from the electric pulse train 6a is twice as long as the expected value E calculated from the electric pulse train 6. The optical communication device 10-1 identifies the pulses in the manner described with reference to FIGS. 7 to 10 in consideration of the double pulse intervals and measures the communication states of the optical ports.

As described above, the optical communication device 10-1 branches the reference optical pulse emitted from the single optical source 3a into the plurality of optical pulses, sets the different time delays for the branched optical pulses, causes the optical pulses to pass through the optical ports of the optical connectors c1 and c2, and causes the reflector 3d included in the optical multiplexer 12-1 to reflect the optical pulses. The optical communication device 10-1 multiplexes the reflected optical pulses, causes the PD 3b to receive the optical pulses, and measures the levels of the electric pulses.

Thus, the optical communication device 10-1 can easily measure the communication states of the optical ports and can improve the efficiency of the measurement. In addition, the constituent elements that are the optical source 3a, the PD 3b, the measuring processor 3c and the like and related to the measurement can be arranged in the single unit without being arranged in a plurality of units. Thus, the size of the measuring system can be reduced.

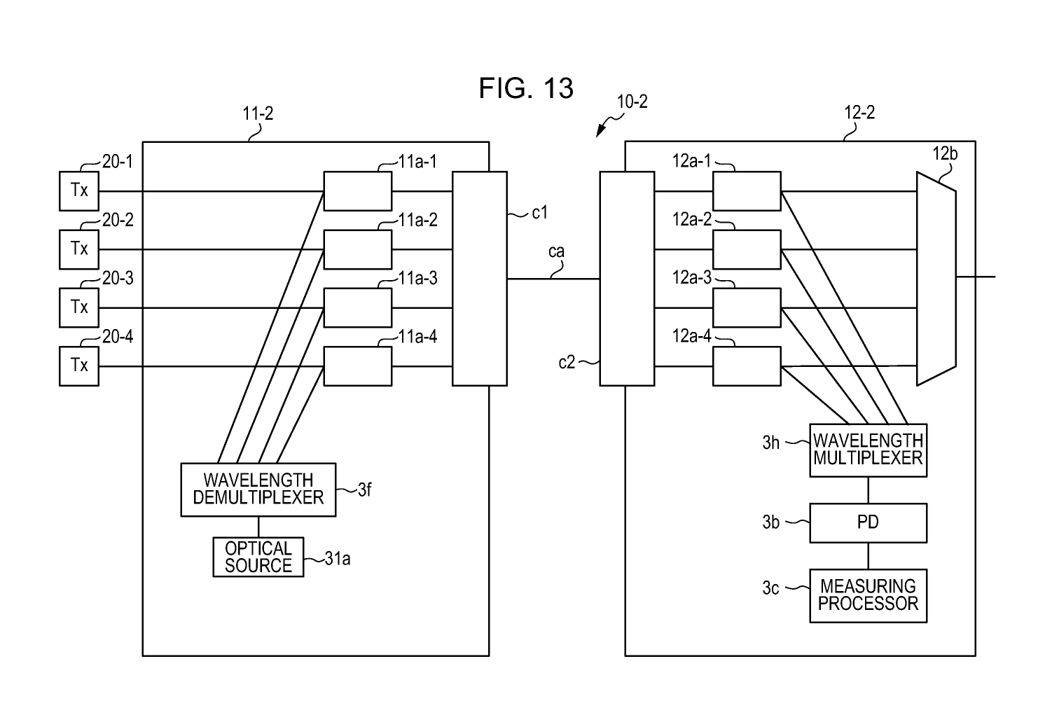

Next, a second modified example is described. FIG. 13 is a diagram illustrating the second modified example of the configuration of the optical communication device 10. An optical communication device 10-2 includes an optical add controller 11-2 and an optical multiplexing controller 12-2. The optical add controller 11-2 includes an optical source 31a, a wavelength demultiplexer 3f, the optical couplers 11a-1 to 11a-4 and the optical connector c1. The optical multiplexing controller 12-2 includes the optical couplers 12a-1 to 12a-4, the optical multiplexer 12b, a wavelength multiplexer 3h, the PD 3b, the measuring processor 3c and the optical connector c2.

The optical source 31a is a wavelength tunable optical source and emits light with arbitrary wavelengths. The wavelength demultiplexer 3f has a function of demultiplexing the light on a wavelength basis and outputs the light with the wavelengths from output ports that are provided for the different wavelengths. For example, the wavelength demultiplexer 3f is a demultiplexer, and this feature is applied to the embodiment described below.

For example, the optical source 31a emits light with different wavelengths λ1 to λ4. In this case, the wavelength demultiplexer 3f outputs the light with the wavelength λ1 to the optical coupler 11a-1 and outputs the light with the wavelength λ2 to the optical coupler 11a-2. In addition, the wavelength demultiplexer 3f outputs the light with the wavelength λ3 to the optical coupler 11a-3 and outputs the light with the wavelength λ4 to the optical coupler 11a-4.

The wavelength multiplexer 3h multiplexes the light that has the different wavelengths λ1 to λ4 and has passed through the optical couplers 11a-1 to 11a-4, the optical couplers c1 and c2 and the optical couplers 12a-1 to 12a-4. The PD 3b converts the multiplexed light into electric signals. The measuring processor 3c measures the levels of the electric signals corresponding to the wavelengths and determines the communication states of the optical ports on the basis of the levels of the electric signals.

As described above, the optical communication device 10-2 emits the light with the different wavelengths from the wavelength-variable optical source, demultiplexes the light on a wavelength basis, causes the PD 3b to receive the light transmitted through the optical ports of the optical connectors c1 and c2, and measures the levels of the electric signals. Thus, the optical communication device 10-2 can easily measure the communication states of the optical ports and can improve the efficiency of the measurement.

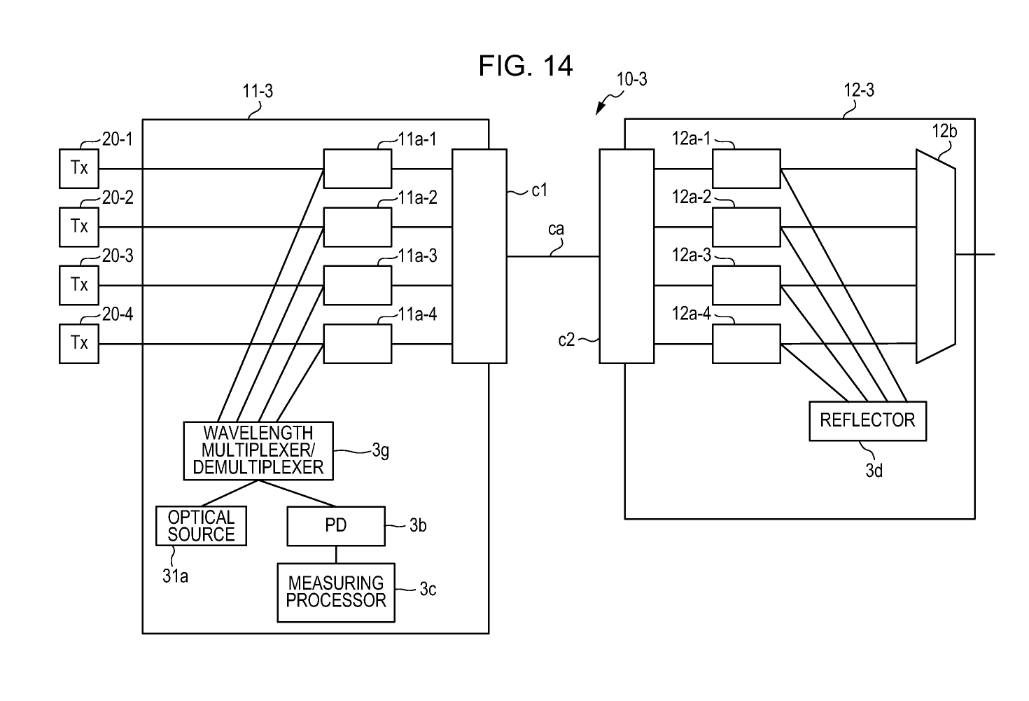

Next, a third modified example is described. FIG. 14 is a diagram illustrating the third modified example of the configuration of the optical communication device 10. An optical communication device 10-3 includes an optical add controller 11-3 and an optical multiplexing controller 12-3. The optical add controller 11-3 includes the optical couplers 11a-1 to 11a-4, a wavelength multiplexer/demultiplexer 3g, the optical source 31a, the PD 3b, the measuring processor 3c and the optical connector c1. The optical multiplexing controller 12-3 includes the optical couplers 12a-1 to 12a-4, the optical multiplexer 12b, the reflector 3d and the optical connector c2.

The optical source 31a emits light with arbitrary wavelengths. The wavelength multiplexer/demultiplexer 3g outputs the light with the wavelengths from output ports that are provided for the different wavelengths. It is assumed that the optical source 31a emits light with different wavelengths λ1 to λ4. Based on this assumption, the wavelength multiplexer/demultiplexer 3g outputs the light with the wavelength λ1 to the optical coupler 11a-1 and outputs the light with the wavelength λ2 to the optical coupler 11a-2. In addition, the wavelength multiplexer/demultiplexer 3g outputs the light with the wavelength λ3 to the optical coupler 11a-3 and outputs the light with the wavelength λ4 to the optical coupler 11a-4.

The reflector 3d reflects the light that has passed through the optical couplers 11a-1 to 11a-4, the optical connectors c1 and c2 and the optical couplers 12a-1 to 12a-4. Specifically, the reflector 3d reflects the light output from the optical coupler 12a-1 so as to return the light to the optical coupler 12a-1, and reflects the light output from the optical coupler 12a-2 so as to return the light to the optical coupler 12a-2. The reflector 3d reflects the light output from the optical coupler 12a-3 so as to return the light to the optical coupler 12a-3, and reflects the light output from the optical coupler 12a-4 so as to return the light to the optical coupler 12a-4.

The optical couplers 12a-1 to 12a-4 output the light reflected and returned by the reflector 3d toward the optical connector c2. The optical couplers 11a-1 to 11a-4 receive the reflected light through the optical connector c1 and transmit the reflected light to the wavelength multiplexer/demultiplexer 3g.

The wavelength multiplexer/demultiplexer 3g multiplexes the reflected light with the wavelengths and thereby generates multiplexed light. Then, the wavelength multiplexer/demultiplexer 3g outputs the multiplexed light to the PD 3b. The PD 3b receives the multiplexed light and converts the multiplexed light into electric signals. The measuring processor 3c measures the levels of the electric signals corresponding to the wavelengths and determines the communication states of the optical ports on the basis of the levels of the electric signals.

As described above, the optical communication device 10-3 emits the light with the different wavelengths from the wavelength-variable optical source 31a, demultiplexes the light on a wavelength basis, causes the light to pass through the optical ports of the optical connectors c1 and c2, and causes the reflector 3d (included in the optical multiplexing controller 12-3) to reflect the light. Then, the optical communication device 10-3 multiplexes the reflected light, causes the PD 3b to receive the reflected light and measures the levels of the electric signals. Thus, the optical communication device 10-3 can easily measure the communication states of the optical ports and can improve the efficiency of the measurement.

In addition, the constituent elements that are the optical source 31a, the PD 3b and the measuring processor 3c and related to the measurement can be arranged in the single unit without being arranged in a plurality of units. Thus, the size of the measuring system can be reduced.

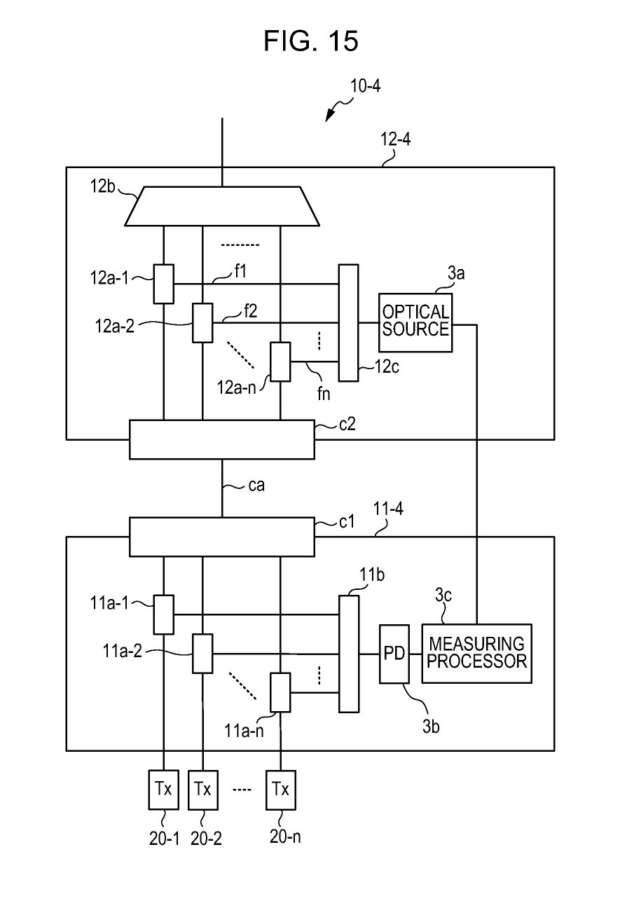

Next, a fourth modified example is described. FIG. 15 is a diagram illustrating the fourth modified example of the configuration of the optical communication device 10. An optical communication device 10-4 includes an optical add controller 11-4 and an optical multiplexing controller 12-4. The optical fibers f1 to fn and the optical source 3a, which are included in the optical communication device 10 illustrated in FIG. 2, are arranged in the optical multiplexing controller 12-4. The PD 3b and the measuring processor 3c are arranged in the optical add controller 11-4.

The optical add controller 11-4 includes the optical couplers 11a-1 to 11a-n, the optical coupler 11b, the PD 3b, the measuring processor 3c and the optical connector c1. The optical multiplexing controller 12-4 includes the optical couplers 12a-1 to 12a-n, the optical coupler 12c, the optical multiplexer 12b, the optical source 3a and the optical connector c2.

In the optical communication device 10-4, optical pulses flow in a direction that is opposite to a direction in which main signal light flows. Thus, the wavelengths of the optical pulses can be equal to wavelengths of the main signal light.

The optical source 3a emits a reference optical pulse on the basis of a timing instruction transmitted from the measuring processor 3c. The optical coupler 12c branches the reference optical pulse into optical pulses and outputs the branched optical pulses to the optical couplers 12a-1 to 12a-n.

The optical coupler 12c is connected to the optical couplers 12a-1 to 12a-n through the optical fibers f1 to fn for which time delays that are different from each other are set. The optical pulses, which are branched by the optical coupler 12c, reach the optical couplers 12a-1 to 12a-n after the time delays set for the optical fibers f1 to fn.

The optical couplers 12a-1 to 12a-n transmit the optical pulses toward the optical connector 2c. The optical couplers 11a-1 to 11a-n transmit the optical pulses received through the optical connector c1 to the optical coupler 11b. The optical coupler 11b couples the optical pulses and thereby generates an optical pulse train. The optical coupler 11b transmits the generated optical pulse train to the PD 3b.

The PD 3b converts the optical pulse train output from the optical coupler 11b into an electric pulse train. The measuring processor 3c receives the electric pulse train. The measuring processor 3c measures the levels of electric pulses included in the electric pulse train and determines the communication states of the optical ports on the basis of the levels of the electric pulses. Details of the measurement are the same as the details described with reference to FIGS. 7 to 10, and a description thereof is omitted.

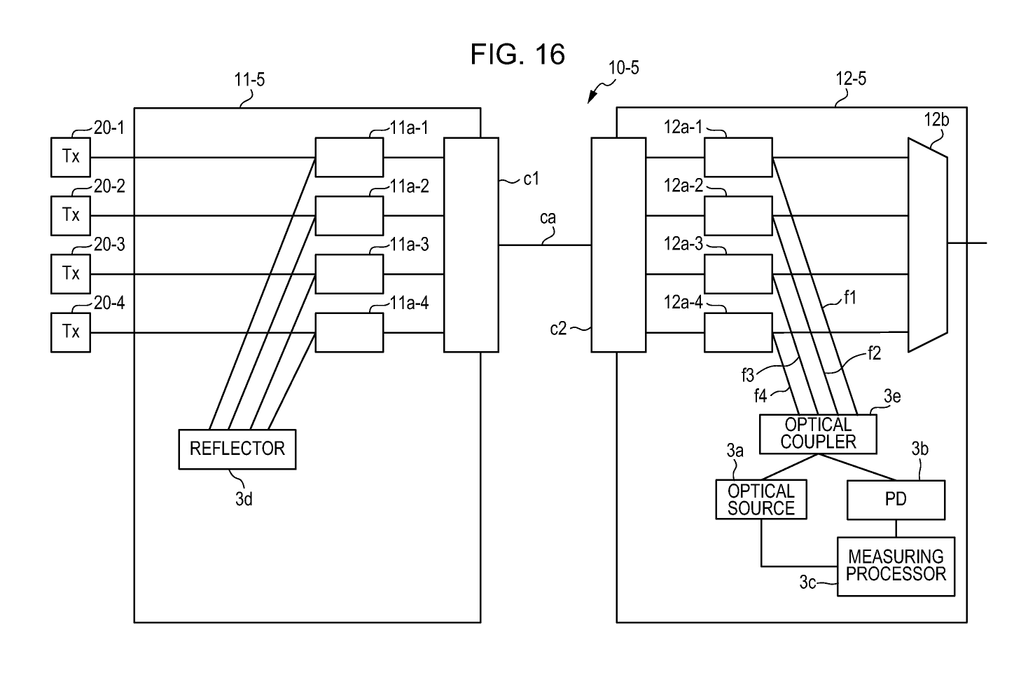

Next, a fifth modified example is described. FIG. 16 is a diagram illustrating the fifth modified example of the configuration of the optical communication device 10. An optical communication device 10-5 includes an optical add controller 11-5 and an optical multiplexing controller 12-5. The optical fibers f1 to f4, the optical source 3a, the PD 3b, the measuring processor 3c and the optical coupler 3e, which are included in the optical communication device 10-1 illustrated in FIG. 11, are arranged in the optical multiplexing controller 12-5. The reflector 3d is arranged in the optical add controller 11-5.

The optical add controller 11-5 includes the optical couplers 11a-1 to 11a-4, the reflector 3d and the optical connector c1. The optical multiplexing controller 12-5 includes the optical couplers 12a-1 to 12a-4, the optical multiplexer 12b, the optical coupler 3e, the optical source 3a, the PD 3b, the measuring processor 3c and the optical connector c2.

The optical source 3a emits a reference optical pulse on the basis of a timing instruction transmitted by the measuring processor 3c. The optical coupler 3e branches the reference optical pulse into optical pulses and outputs the branched optical pulses to the optical couplers 12a-1 to 12a-4.

The optical coupler 3e is connected to the optical couplers 12a-1 to 12a-4 through the optical fibers f1 to f4 for which time delays that are different from each other are set. The branched optical pulses reach the optical couplers 12a-1 to 12a-4 after the time delays set to the optical fibers f1 to f4.

The optical couplers 12a-1 to 12a-4 transmit the optical pulses to the optical connector c2. The optical couplers 11a-1 to 11a-4 transmit the optical pulses received through the optical connector c1 to the reflector 3d. The reflector 3d reflects the optical pulse (light) output from the optical coupler 11a-1 so as to return the optical pulse to the optical coupler 11a-1 and reflects the (optical pulse (light) output from the optical coupler 11a-2 so as to return the optical pulse to the optical coupler 11a-2. The reflector 3d reflects the optical pulse (light) output from the optical coupler 11a-3 so as to return the optical pulse to the optical coupler 11a-3 and reflects the optical pulse (light) output from the optical coupler 11a-4 so as to return the optical pulse to the optical coupler 11a-4.

The optical couplers 11a-1 to 11a-4 output the optical pulses reflected and returned by the reflector 3d toward the optical connector c1. When the optical couplers 12a-1 to 12a-4 receive the optical pulses through the optical connector c2, the optical couplers 12a-1 to 12a-4 transmit the reflected optical pulses to the optical coupler 3e.

The optical coupler 3e couples the four reflected optical pulses and thereby generates an optical pulse train. The optical coupler 3e outputs the generated optical pulse train to the PD 3b. The PD 3b converts the optical pulse train output from the optical coupler 3e into an electric pulse train. The measuring processor 3c receives the electric pulse train. The measuring processor 3c measures the levels of electric pulses included in the electric pulse train and determines the communication states of the optical ports on the basis of the levels of the electric pulses.

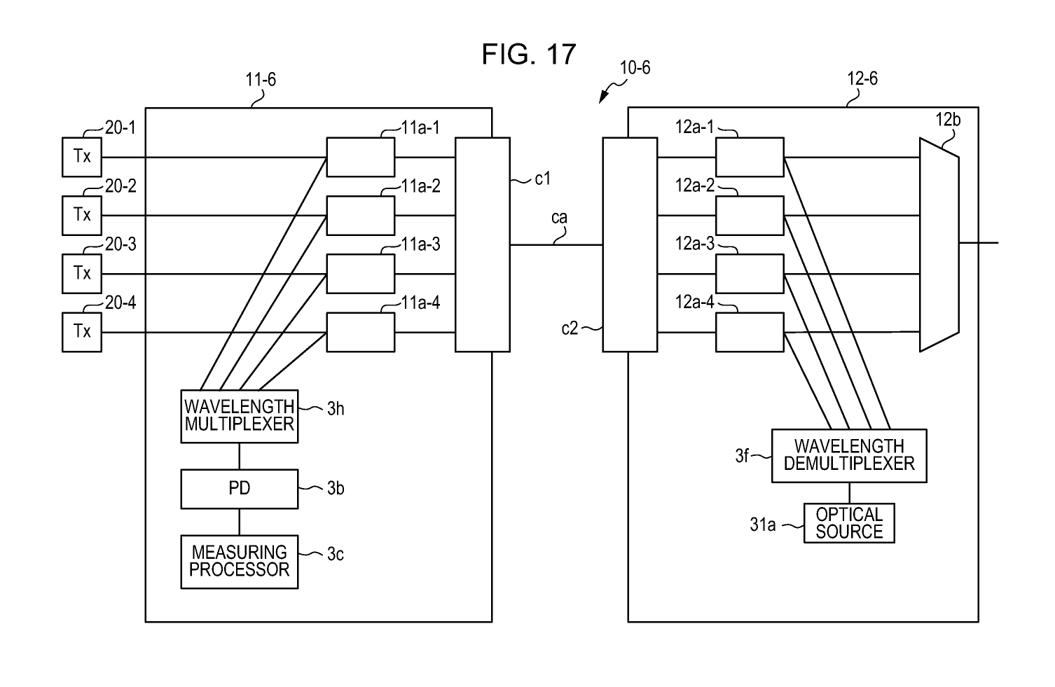

Next, a sixth modified example is described. FIG. 17 is a diagram illustrating the sixth modified example of the configuration of the optical communication device 10. An optical communication device 10-6 includes an optical add controller 11-6 and an optical multiplexing controller 12-6. The optical source 31a and the wavelength demultiplexer 3f, which are included in the optical communication device illustrated in FIG. 13, are arranged in the optical multiplexing controller 12-6. The wavelength multiplexer 3h, the PD 3b and the measuring processor 3c are arranged in the optical add controller 11-6.

The optical add controller 11-6 includes the optical couplers 11a-1 to 11a-4, the wavelength multiplexer 3h, the PD 3b, the measuring processor 3c and the optical connector c1. The wavelength multiplexer 12-6 includes the optical couplers 12a-1 to 12a-4, the optical multiplexer 12b, the wavelength demultiplexer 3f, the optical source 31a and the optical connector c2.

The optical source 31a is a wavelength tunable optical source and emits light with arbitrary wavelengths. The wavelength demultiplexer 3f has a function of demultiplexing the light on a wavelength basis and outputs the light with the wavelengths from the optical ports that are provided for the different wavelengths.

It is assumed that the optical source 31a outputs light with wavelengths λ1 to λ4 that are different from each other. Based on this assumption, the wavelength demultiplexer 3f outputs the light with the wavelength λ1 to the optical coupler 12a-1 and outputs the light with the wavelength λ2 to the optical coupler 12a-2. In addition, the wavelength demultiplexer 3f outputs the light with the wavelength λ3 to the optical coupler 12a-3 and outputs the light with the wavelength λ4 to the optical coupler 12a-4.

The wavelength multiplexer 3h multiplexes the light that has the different wavelengths and has passed through the optical couplers 12a-1 to 12a-4, the optical connectors c1 and c2 and the optical couplers 11a-1 to 11a-4. The PD 3b converts the multiplexed light into electric signals. The measuring processor 3c measures the levels of the electric signals corresponding to the wavelengths and determines the communication states of the optical ports on the basis of the levels of the electric signals.

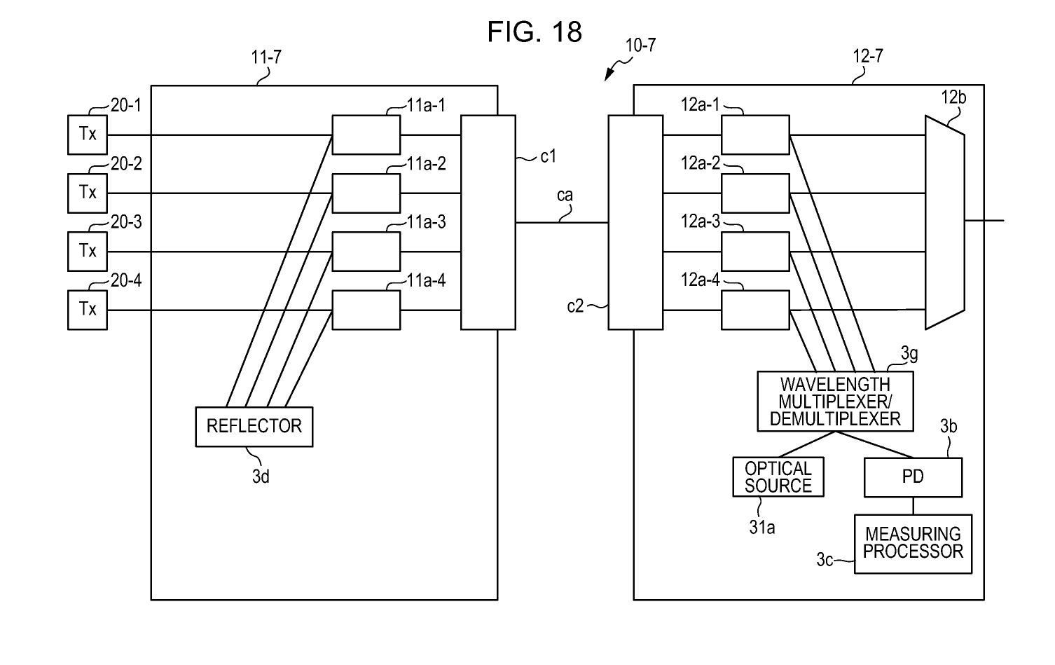

Next, a seventh modified example is described. FIG. 18 is a diagram illustrating the seventh modified example of the configuration of the optical communication device 10. An optical communication device 10-7 includes an optical add controller 11-7 and an optical multiplexing controller 12-7. The wavelength multiplexer/demultiplexer 3g, the optical source 31a, the PD 3b and the measuring processor 3c, which are included in the optical communication device 10-3 illustrated in FIG. 14, are arranged in the optical multiplexing controller 12-7. The reflector 3d is arranged in the optical add controller 11-7.

The optical add controller 11-7 includes the optical couplers 11a-1 to 11a-4, the reflector 3d and the optical connector c1. The optical multiplexing controller 12-7 includes the optical couplers 12a-1 to 12a-4, the optical multiplexer 12b, the wavelength multiplexer/demultiplexer 3g, the optical source 31a, the PD 3b, the measuring processor 3c and the optical connector c2.

The optical source 31a emits light with arbitrary wavelengths. The wavelength multiplexer/demultiplexer 3g outputs the light with the wavelengths from the output ports that are provided for the different wavelengths. It is assumed that the optical source 31a outputs light with wavelengths λ1 to λ4 that are different from each other. Based on this assumption, the wavelength multiplexer/demultiplexer 3g outputs the light with the wavelength λ1 to the optical coupler 12a-1 and outputs the light with the wavelength λ2 to the optical coupler 12a-2. In addition, the wavelength multiplexer/demultiplexer 3g outputs the light with the wavelength λ3 to the optical coupler 12a-3 and outputs the light with the wavelength λ4 to the optical coupler 12a-4.

The reflector 3d reflects the light that has passed through the optical couplers 12a-1 to 12a-4, the optical connectors c1 and c2 and the optical couplers 11a-1 to 11a-4. Specifically, the reflector 3d reflects the light output from the optical coupler 11a-1 so as to return the light to the optical coupler 11a-1, and reflects the light output from the optical coupler 11a-2 so as to return the light to the optical coupler 11a-2. The reflector 3d reflects the light output from the optical coupler 11a-3 so as to return the light to the optical coupler 11a-3, and reflects the light output from the optical coupler 11a-4 so as to return the light to the optical coupler 11a-4.

The optical couplers 11a-1 to 11a-4 output the light reflected and returned by the reflector 3d toward the optical connector c1. When the optical couplers 12a-1 to 12a-4 receive the reflected light through the optical connector c2, the optical couplers 12a-1 to 12a-4 transmit the reflected light to the wavelength multiplexer/demultiplexer 3g.

The wavelength multiplexer/demultiplexer 3g multiplexes the reflected light with the wavelengths and outputs the multiplexed light to the PD 3b. The PD 3b receives the multiplexed light and converts the received light into electric signals. The measuring processor 3c measures the levels of the electric signals corresponding to the wavelengths and determines the communication states of the optical ports on the basis of the levels of the electric signals.

The embodiment is described above. The constituent elements described in the embodiment may be replaced with other parts that have the same functions as the constituent elements. In addition, another arbitrary constituent element and another process may be added.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An optical communication device comprising:
a first transmission unit including:
an optical source configured to emit a reference optical pulse,
an optical splitter configured to branch the reference optical pulse, and generate a plurality of optical pulses,
a plurality of optical fibers configured to have different length to set various time delays for the optical pulses, and
a first optical connector; and
a second transmission unit including:
a second optical connector coupled to the first optical connector,
an optical multiplexer configured to multiplex the optical pulses that have passed through optical ports of the first and second optical connectors, and generate an optical pulse train,
an optical receiver configured to convert the optical pulse train into an electric pulse train, and
a measuring processor configured to determine communication states of the optical ports, based on the levels of electric pulses included in the electric pulse train.

2. The optical communication device according to claim 1, wherein the measuring processor
calculates a time from the emission of the reference optical pulse to the reception of the electric pulse train,
identifies an electric pulse received within a range of the calculated time as a first pulse of the electric pulse train, and
identifies, based on the first pulse and the time delays, the optical ports through which the optical pulses that correspond to the electric pulses included in the electric pulse train have passed.

3. The optical communication device according to claim 1,
wherein the plurality of optical fibers sets, for the optical pulses, various time delays calculated according to a predetermined function,
wherein the measuring processor identifies, based on the time delays, intervals between the electric pulses included in the electric pulse train, and identifies the optical ports through which the optical pulses that correspond to the electric pulses included in the electric pulse train have passed.

4. An optical communication device comprising:
a first transmission unit including:
an optical source configured to emit a reference optical pulse,
an optical splitter configured to branch the reference optical pulse, and generate a plurality of optical pulses,
a plurality of optical fibers configured to have different length to set various time delays for the optical pulses,
an optical multiplexer configured to generate an optical pulse train,
an optical receiver configured to convert the optical pulse train into an electric pulse train,
a measuring processor configured to determine communication states of optical ports, based on the levels of electric pulses included in the electric pulse train, and
a first optical connector; and
a second transmission unit including:
a second optical connector coupled to the first connector, and
a reflector configured to reflect the optical pulses that have passed through the optical ports of the first and second optical connectors, the reflected optical pulses being passed through the optical ports of the first and second optical connectors, and being transmitted to the first transmission unit,
wherein the optical multiplexer multiplexes the reflected optical pulses and generates the optical pulse train.

5. The optical communication device according to claim 4, wherein the measuring processor
calculates a time from the emission of the reference optical pulse to the reception of the electric pulse train,
identifies an electric pulse received within a range of the calculated time as a first pulse of the electric pulse train, and
identifies, based on the first pulse and the time delays including times for returning the optical pulses by means of the reflection, the optical ports through which the optical pulses that correspond to the electric pulses included in the electric pulse train have passed.

6. The optical communication device according to claim 4,
wherein the plurality of optical fibers sets, for the optical pulses, various time delays calculated according to a predetermined function,
wherein the measuring processor identifies, based on the time delays including times for returning the optical pulses by means of the reflection, intervals between the electric pulses included in the electric pulse train, and identifies the optical ports through which the optical pulses that correspond to the electric pulses included in the electric pulse train have passed.

7. An optical communication device comprising:
a first transmission unit including:
a wavelength-variable optical source configured to emit light of different wavelengths,
a wavelength demultiplexer configured to demultiplex the light, based on a wavelength, and
a first optical connector; and
a second transmission unit including:
a second optical connector coupled to the first optical connector,
an optical receiver configured to convert, into electric signals, the light that has the various wavelengths and has passed through optical ports of the first and second optical connectors, and
a measuring processor configured to determine communication states of the optical ports, based on the levels of the electric signals.
